(19) United States
(12) Patent Application Publication
(10) Pub. No.: US 2022/0219332 A1
(43) Pub. Date: Jul. 14, 2022

(54) APPARATUS AND METHOD FOR PICKING UP OBJECTS OFF A SURFACE

(71) Applicant: Technische Universiteit Delft, Delft (NL)

(72) Inventors: Peter Carlo REM, Delft (NL); Simon Petrus Maria BERKHOUT, Delft (NL); Cornelis VAN BEEK, Delft (NL)

(21) Appl. No.: 17/612,856

(22) PCT Filed: May 22, 2020
(86) PCT No.: PCT/NL2020/050332

§ 371 Date: Nov. 19, 2021

(30) Foreign Application Priority Data
May 24, 2019 (NL) 2023190
May 24, 2019 (NL) 2023193

(51) Int. Cl. B25J 13/08; B25J 9/00

(52) U.S. Cl. CPC B25J 13/08; G01D 5/12; B25J 9/0093

(57) ABSTRACT

Apparatus and method for picking up off a surface objects which are on the surface with a spread remaining equal, wherein of the objects a position on the surface is established, and wherein on the basis of the established position a plurality of pickers are centrally controlled to pick up free objects off the surface and to leave objects with mutual overlap lying on the surface.

The invention relates to the picking up of objects off a picking surface.

The automated picking of objects off a picking surface is generally known, and is used, for example, to select objects from a waste flow. Objects are taken out of a waste flow for reuse and in order not to burden the environment. In general, of the objects lying on the picking surface, a scan is made to establish the position of the objects on the picking surface. Then, a picker is controlled to pick up selected objects and, for instance, to sort them according to material type for reuse. Such a picking solution is for instance known from EP2658691. This prior art picking solution is suitable in particular for the automated picking of objects having a variety of shapes and sizes.

While the known picking solution provides advantages for the picking of objects, it has as a disadvantage that it gives a low yield on the investment. That is, the investment cost of such a picking installation is often too high in relation to the throughput of the installation.

Furthermore, the known picking solution has as a disadvantage that the sorting accuracy is not adequate to procure the desired purity for reuse, for example for reuse of metal scrap, such as Zorba or aluminium scrap.

Due to the low yield, in practice particular waste flows are transported from high-wage countries to low-wage countries for manual sorting (handpicking). With all the adverse effects thereof for the environment, in particular because of emission during transport both in exporting the waste flow to the low-wage country and in importing the sorted objects with a residual value back into the high-wage country.

The invention contemplates a method for picking objects off a surface with an improved efficiency and yield, with which, while preserving the advantages mentioned, the disadvantages mentioned can be counteracted. In particular, the invention contemplates a method which can process waste flows in an environment-friendlier and more cost-effective manner, and which can at least compete with manual sorting in low-wage countries, and more particularly has a low investment.

To this end, the invention provides a method for picking up off a surface objects which are on the surface with a spread remaining equal, wherein of the objects a position on the surface is established, and wherein on the basis of the established position a plurality of pickers are centrally controlled to pick up free objects off the surface and to leave objects with mutual overlap lying on the surface.

Leaving objects with a mutual overlap lying on the picking surface can counteract the established position of the objects on the picking surface getting disturbed. The chance of failure of a next picking operation can thereby be reduced. Thus, in particular through central control of the plurality of pickers, a low investment can be obtained, and objects to be picked up can be picked up with a high accuracy. Furthermore, with central control, the necessity for complex sensors with feedback for detecting disturbances in the established position of objects can be obviated. As a result, a cost-effective method can be employed for picking objects off a surface with a high throughput.

When the plurality of pickers are controlled to leave mutually abutting objects lying on the surface, this can further counteract the established position of the objects on the picking surface getting disturbed.

When the plurality of pickers are controlled to pick only free objects with a minimum free circumferential zone around the object, in particular a minimum free circumferential zone from the circumference of the free object as projected on the surface, of between 5-50 mm, preferably between 10-40 mm and more preferably between 20-30 mm, it can be achieved that the pickers can pick up objects accurately, and a high throughput can be attained.

When the plurality of pickers are centrally controlled to execute commands blindly, relatively simple pickers can be used. In particular when each picker of the plurality of pickers is unaware of its absolute spatial position, the necessity for pickers provided with relatively complex sensors with feedback on a real spatial position can be avoided. As a result, with a plurality of relatively inexpensive pickers, the method for picking up objects off a surface can be carried out with a high throughput in a particularly cost-effective manner.

When the pickers are centrally controlled in a master/slave configuration where the slave configuration of the pickers is limited to passive feedback, it can be achieved that picking is carried out relatively simply and highly cost-effectively. Thus, the pickers limited to passive feedback cannot, during the execution of a command, interfere to adjust a picking operation. With passive feedback of the picker, however, feedback can be obtained, for example, on the execution of a command, on whether a picking operation is successful or not or on internal forces in a picker for a mass determination of the object to be picked.

By taking a 3D scan of the objects, in particular an infrared 3D scan, whereby on the basis of the 3D scan a height map of the objects on the surface is determined, relatively simply a distinction can be made between the surface and the objects lying thereon. This can counteract determination of the position of objects on the surface being disturbed by contaminants such as stains and smears on the surface. In addition, sharp transitions in the height map can advantageously be indicative of a mutual overlap between objects spread on the surface, as a result of which the picking of free objects is promoted.

When the objects spread on the surface give the surface a degree of coverage that is in the range of 10-40% of the area of the surface, and in particular is at least 15% of the area of the surface, and in particular is not more than 30% of the area of the surface, a relatively large part of the surface can be covered by objects while it can be guaranteed that at least a part of the objects lie clear of other objects on the surface. In this way, a relatively high throughput can be achieved, and effective use can be made of the available space on the surface for processing waste flows. In the context of this application, a degree of coverage is to be taken as a measure of coverage of the surface by objects, in particular a percentage of the surface that is covered by objects.

When at least 40% of the objects on the surface have an overlapping position, preferably at least 60%, and in particular less than 90% of the objects on the surface have an overlapping position, a high degree of coverage of objects spread on the surface can be achieved and hence a high throughput can be attained. Advantageously, at least 10% of the objects on the surface lie free so that the picking up of free objects can be guaranteed.

By controlling the pickers to preferentially pick up off the surface free objects being relatively large with respect to others, it can be achieved that the yield per unit time is augmented. This is to say that the volume that is picked per unit time is increased upon preferential picking of relatively large free objects and thus work is done cost-effectively.

When a substantially homogeneous magnetic field and the surface with objects are moved relative to each other, such that the substantially homogeneous magnetic field excites a magnetic moment in ferromagnetic objects being on the surface while the spread of the objects on the surface remains equal, ferromagnetic objects can be magnetized while disturbance of the spread of the objects on the surface is counteracted. In particular, the ferromagnetic objects may be connected with or form part of non-ferromagnetic objects. Thus, for example, in a flow of Zorba or aluminium scrap, ferromagnetic impurities, such as iron and steel alloys, may be present on and/or in substantially aluminium objects. When the excited moment, at least a component thereof, is observed, ferromagnetic objects and/or non-ferromagnetic objects with ferromagnetic impurities can be relatively simply recognized. The component mentioned is in particular parallel to the direction of the substantially homogeneous magnetic field. It will be clear that the observation need not be limited to the component mentioned. In this way, ferromagnetic objects and/or non-ferromagnetic objects with ferromagnetic impurities can, during the sorting of e.g. Zorba or aluminium scrap, be relatively simply avoided and/or, if so desired, be picked up and removed.

Advantageously, the substantially homogeneous magnetic field can extend in the relative movement direction. Preferably, the substantially homogeneous magnetic field extends parallel along the surface. Elegantly, the substantially homogeneous magnetic field and the surface with objects are moved along each other, for example in that the objects are moved on a transport surface in a transport direction along a magnet.

When the substantially homogeneous magnetic field comprises a magnetic field strength gradient which is less than 200 mT/m, as, for example, less than 100 mT/m or less than 50 mT/m, a magnetic moment can be excited in ferromagnetic objects while movement of the particle along this gradient is counteracted. This can further promote the spread of objects on the surface remaining equal.

By the use of a relatively weak substantially homogeneous magnetic field, in particular a magnetic field strength which is less than 100 mT, as, for example, less than 50 mT or less than 25 mT, a magnetic moment can be excited in ferromagnetic objects while in practice, with objects in a waste flow, of which a smallest fraction e.g. with a screen size which is less than 20 mm has been sieved, movement by attraction of the magnetic field can be hindered. This can still further promote the spread of objects on the surface remaining equal.

Advantageously, a position and/or dimension of the ferromagnetic object is established on the basis of the observed magnetic moment. The magnetic moment can be observed with the aid of a sensor device, which may comprise one or more magnetic field sensors, in particular Hall sensors and/or inductive sensors such as pickup coils.

While a Hall sensor generally measures a component of the magnetic field, a pickup coil generally measures the derivative of such a component in time. In the context of the current invention, an advantage of pickup coils is that substantially only field changes are measured, which are caused, for example, by the passage of a magnetized iron particle. An advantage of Hall sensors is a relatively low noise level. It will be clear that both types of sensor are in principle suitable for observing the magnetic moment.

The sensor device can comprise a plurality of magnetic field sensors each with a known relative position with respect to each other, and where, in particular, the plurality of magnetic field sensors can form an array.

Such a substantially homogeneous magnetic field can be used more broadly, for example in a method for picking up off a surface objects which are on the surface with a spread remaining equal, wherein of the objects a position on the surface is established, wherein on the basis of the established position at least one picker is controlled to pick up objects off the surface, wherein a substantially homogeneous magnetic field and the surface with objects are moved relative to, along each other, such that the substantially homogeneous magnetic field excites a magnetic moment in ferromagnetic objects being on the surface while the spread of the objects on the surface remains equal, wherein the excited magnetic moment, at least a component thereof, is observed. The component mentioned is, in particular, parallel to the direction of the substantially homogeneous magnetic field. It will be clear that the observation need not be limited to the component mentioned.

By furthermore controlling the pickers, at picking, to leave objects bounding the free circumferential zone untouched, disturbance of the remaining objects on the picking surface can be further counteracted.

When the pickers are controlled, at picking, to counteract both rotation of the object relative to the surface and translation of the object along the surface, disturbance of the spread during picking can be counteracted further. In particular, when objects to be picked up are engaged at three predetermined points, a relatively stable, statically determined engagement can be guaranteed.

When the pickers are controlled, at picking of the objects, to move substantially transversely to the picking surface, it can be achieved that objects remain lying in the surface untouched, which further reduces the chance of disturbance.

When the surface travels during picking, preferably in the transport direction along the pickers, a continuous waste flow can be got started, as a result of which the throughput is increased in a relatively simple manner.

By respreading objects remaining on the surface, whereby of the respread objects a next position on the surface is established, and whereby on the basis of the established next positions again a plurality of pickers are controlled to pick up free objects off the surface and to leave objects with mutual overlap lying on the surface, it can be achieved that objects being on the picking surface with a mutual overlap come to lie clear after respreading. In this way, the throughput can be further enlarged. For this, for example, the same plurality of pickers can be used, but also a next plurality of pickers may be controlled.

In particular, respreading in combination with the preferential picking off the surface of free objects being relatively large with respect to others may be particularly advantageous for improving the throughput. The joint projection of the objects on the surface is characterized by a spatial fill factor. Projections of relatively small objects which, for example without overlap, fill the surface with a particular fill factor, have on average mutually smaller interstitial interspaces than projections of relatively large objects which fill the same surface with the same fill factor. According to this principle, therefore, there is more chance that relatively large objects after respreading cause an overlap in a next position, than the other way around. The chance that a relatively large object after respreading overlaps with a relatively small object is in fact greater than the chance that a relatively small object after respreading overlaps with a relatively large object. The relatively small objects have in fact a greater chance of ending up in a mutual interstitial interspace without overlap than relatively large objects, regardless of the composition of the fill factor. That is, regardless of dimensions of the projections jointly filling the surface with a particular fill factor.

Advantageously, according to a greedy algorithm the throughput can be further optimized. The greedy algorithm works according to a covering capacity principle, taking into account both a projection area of objects on the surface and a convex circumference of objects located on the surface. Thus, free objects with the largest covering capacity can be identified according to the function

$$A + \frac{{P}^{2}}{2 π}$$

wherein A is the projection area of an object on the surface and P is the convex circumference (perimeter) of an object lying on the surface. In particular, the pickers can be controlled to preferentially pick off the surface free objects with a covering capacity which is relatively large with respect to others. In this way, the throughput can be improved still further.

When objects which are on the transport surface with a mutual spread remaining the same are part of a waste flow, in particular metal scrap, more in particular a flow of Zorba and/or aluminum scrap, particles having a relatively high residual value can be effectively recycled. As a result, a relatively high yield on the investment cost can be attained. It will be clear to the skilled person that, for example, beaten and cast aluminium scrap, bronze scrap, brass scrap, zinc scrap, refined scrap and iron scrap also belong to waste flows. In addition, for example, also household refuse, plastic and other waste flows can be recycled in this way.

When of the objects a material type, in particular a type of metal or grade of alloy, is determined, and where the picked objects are sorted according to material type, efficiency and yield can be augmented further.

When after the above-described respreading step of the remaining objects, again a material type is determined, and where, with a feedforward, data on the earlier determined material types of objects are put through, the earlier determined material type, after respreading, can again be evaluated and checked. Consequently, in case of doubt about the material type, an object may be left lying on the surface. In this manner, after respreading, for instance from a different viewpoint, the material type of the object may be determined again. Thus, by means of at least one respreading step together with the feedforward, the accuracy of the material type determination can be improved and efficiency and yield of the method can be augmented still more.

The invention also relates to a picking apparatus comprising a picking surface for spreading objects thereon, wherein the picking apparatus is provided with a scanner for establishing a position of the objects on the picking surface, wherein the picking apparatus furthermore comprises a plurality of pickers, which are arranged along the picking surface and are centrally controlled by a control to pick free objects off the picking surface and to leave objects with mutual overlap lying on the picking surface.

By leaving objects with a mutual overlap lying on the picking surface, the established position of the objects on the picking surface getting disturbed can be counteracted. Thus, in particular by central control of the plurality of pickers, a high throughput can be obtained, and objects to be picked can be picked up with a high accuracy.

When the picking apparatus comprises a feeding device, which is configured to spread objects randomly on the picking surface, while the feeding device is configured to bring about with the spread objects a degree of coverage of the picking surface in the range of 10-40% of the area of the picking surface, and in particular is at least 15% of the area of the picking surface, and in particular is not more than 30% of the area of the picking surface, such that as a result of the random spread and the degree of coverage at least a part of the objects are on the picking surface with mutual overlap, a relatively high throughput and hence a relatively high yield can be achieved.

When the picking apparatus comprises a discharge for discharging picked objects, the picked objects can be relatively simply sorted, for example into bins or compartments next to the picking surface. By providing the picking apparatus with one or more bins for receiving sorted discharged objects, the objects can be relatively simply separated, e.g. according to material type, type of metal, and/or alloy grade. In this manner, sorted objects can relatively easily be made available for efficient reuse.

By setting up the control and the plurality of pickers, respectively, in a master/slave configuration, where the pickers can blindly execute commands from the control, with the slave configuration of the pickers being limited to passive feedback, the picking apparatus with relatively inexpensive ‘dumb’ pickers can suffice. In the context of this application, ‘dumb’ pickers is understood to mean pickers without active feedback. This is to say that the ‘dumb’ pickers cannot themselves interfere to adjust a picking operation and no spatial position determination of the respective pickers is available. Furthermore, in the context of this application, ‘dumb’ pickers is understood to mean that they possibly do have passive feedback, as, for example, passive feedback on the picking operation being successful or not or passive feedback of weight determination of the object to be picked. By recording what objects have not been picked correctly, a movement of the pickers as prescribed by the control can be adjusted for later similar objects.

When each of the plurality of pickers comprises three fingers movable independently of each other, with the fingers configured to each engage an object at different points, the points of engagement being predetermined by the control, this can counteract an object moving and/or rotating at picking. This can counteract, at picking, the remaining objects on the picking surface getting disturbed, thereby reducing the chance of failure of a next picking operation. The control may, for example, calculate and/or estimate of each of the objects to be picked a number of quantities, such as for example an area and/or center of gravity of the particle. On the basis of these quantities, the mechanics of the objects can be assessed. By, for a relatively large number of combinations of points of engagement and engagement forces of the different fingers, estimating the success percentage on the basis of these data and historical data of the success of previous picking operations with comparable mechanics and engagement, the failure of future picking operations can be further reduced (machine learning). In this way, the throughput for the picking of objects can be augmented further.

When the picking surface comprises a transport surface which during picking travels in a transport direction along the plurality of pickers, the throughput can be increased further, which improves efficiency and yield on the investment.

The picking apparatus can comprise a respreader for respreading objects remaining on the picking surface, in particular wherein the respreader comprises a transition from the transport surface to a further transport surface, with the transition being or forming a cascade. As a result, objects which are on the picking surface with a mutual overlap can be shaken up and/or respread. In this way, objects can be respread and previously overlapping objects can come to lie clear, as a result of which the throughput is relatively simply augmented. This works well in particular when preferentially free objects being relatively large with respect to others are picked off the picking surface. By preferentially picking relatively large free objects, the chance of overlapping objects upon a next spreading is smaller, since large objects have a larger contact surface. As a result, the throughput can be relatively simply augmented still further.

Advantageously, the control can comprise a greedy algorithm which is configured to preferentially pick off the surface free objects being relatively large with respect to others, in particular free objects having a relatively large covering capacity with respect to others.

The picking apparatus can comprise for the further transport surface a second scanner and a second plurality of pickers, wherein the second plurality of pickers are centrally controlled by the control and/or a second control to pick free objects off the further transport surface and leave objects with mutual overlap lying on the further transport surface. As a result, in a relatively simple manner the throughput can be augmented further. Of course, the picking apparatus can also comprise more than two transport surfaces, where each transport surface may be provided with a scanner, a plurality of pickers and/or a control. In this way, each iteration can form a subsystem of the picking apparatus. The picking apparatus can comprise, for example, at least three subsystems, as, for example, between 5-10 subsystems, where each subsystem can comprise a transport surface, a scanner, a plurality of pickers and/or a control.

When the plurality of pickers are or comprise at least five pickers, the throughput can be augmented cost-effectively. Advantageously, the plurality of pickers can comprise at least five pickers, as, for example, at least ten pickers or at least fifteen pickers, and in particular about twenty pickers. When starting, for instance, from a plurality of about 20 pickers per above-described subsystem, the picking apparatus can comprise in total, for example, between about 40-200 pickers.

By providing each of the pickers with a mass determination provision, such as a strain gauge or the electric power of a drive of the picker, during picking a real mass of an object to be picked can be determined. Thus, a control-predetermined, expected mass of the objects to be picked can, during picking, be passively checked against a real mass of that object. In this way, the accuracy of the picking apparatus may, for instance with the aid of machine learning, be further augmented, efficiency and yield being thereby improved still more.

Advantageously, the picking apparatus can comprise a static magnet with a substantially homogeneous magnetic field, wherein at least one of the static magnet and the picking surface is arranged movably relative to the other, wherein the picking apparatus is furthermore provided with a sensor device which is configured for observing a magnetic moment, excited by the substantially homogeneous magnetic field, in ferromagnetic objects being on the picking surface. In particular when the picking surface comprises a substantially plane, flat surface.

The substantially homogeneous magnetic field can comprise a magnetic field strength gradient which is less than 200 mT/m, as, for example, less than 100 mT/m or less than 50 mT/m. The substantially homogeneous magnetic field can have a magnetic field strength which is less than 100 mT, as, for example, less than 50 mT or less than 25 mT.

When the static magnet is arranged under the picking surface, in particular the above-described transport surface, such that the substantially homogeneous magnetic field extends parallel along the picking surface, the objects on the picking/transport surface coming into collision with the static magnet can be counteracted. In this manner, disturbance of the spread of objects on the surface can be counteracted.

Advantageously, the static magnet may be arranged such that the substantially homogeneous magnetic field extends substantially in the transport direction of the transport surface. In particular, the transport surface with objects can be movable relative to the stationarily arranged static magnet in the transport direction.

By arranging the sensor device on the static magnet, the construction can be of compact design. Advantageously, the sensor device can comprise a plurality of magnetic field sensors, each with a known relative position with respect to each other, and in particular a position whereby the plurality of magnetic field sensors form an array.

Such a static magnet with a substantially homogeneous magnetic field can be applied more broadly, for example in a picking apparatus comprising a picking surface for spreading objects thereon, a scanner for establishing a position of the objects on the picking surface, at least one picker which is arranged along the picking surface to pick objects off the picking surface, a static magnet having a substantially homogeneous magnetic field, wherein at least one of the static magnet and the picking surface is arranged movably relative to the other, wherein the picking apparatus furthermore includes a sensor device which is configured for observing a magnetic moment, excited by the substantially homogeneous magnetic field, in ferromagnetic objects being on the picking surface.

The invention furthermore relates to a method for picking up off a surface objects which are on the surface with a spread remaining equal, wherein of the objects a position on the surface is established, wherein on the basis of the established position at least one picker is controlled to pick objects off the surface, wherein a substantially homogeneous magnetic field and the surface with objects are moved relative to each other, such that the substantially homogeneous magnetic field excites a magnetic moment in ferromagnetic objects being on the surface while the spread of the objects on the surface remains equal, wherein the excited magnetic moment, at least a component thereof, is observed. The component mentioned is in particular parallel to the direction of the substantially homogeneous magnetic field. It will be clear that the observation need not be confined to the component mentioned.

Optionally, the substantially homogeneous magnetic field can comprise a magnetic field strength gradient which is less than 200 mT/m, in particular less than 100 mT/m, more particularly less than 50 mT/m.

Optionally, the substantially homogeneous magnetic field can have a magnetic field strength which is less than 100 mT, in particular less than 50 mT, more particularly less than 25 mT.

Advantageously, the magnetic moment can be observed with the aid of a sensor device, in particular one or more Hall sensors and/or inductive sensors such as pickup coils.

Elegantly, on the basis of the observed magnetic moment, a position of the ferromagnetic object can be established.

Elegantly, on the basis of the observed magnetic moment, a dimension of the ferromagnetic object can be established.

Optionally, on the basis of the established position, the at least one picker can be controlled to pick up free objects off the surface and to leave objects with mutual overlap lying on the surface.

The invention also relates to a picking apparatus comprising a picking surface for spreading objects thereon, a scanner for establishing a position of the objects on the picking surface, at least one picker which is arranged along the picking surface to pick objects off the picking surface, a static magnet with a substantially homogeneous magnetic field, wherein at least one of the static magnet and the picking surface is arranged movably relative to the other, wherein the picking apparatus is furthermore provided with a sensor device which is configured for observing a magnetic moment, excited by the substantially homogeneous magnetic field, in ferromagnetic objects being on the picking surface.

Optionally, the substantially homogeneous magnetic field can comprise a magnetic field strength gradient which is less than 200 mT/m, in particular less than 100 mT/m, more particularly less than 50 mT/m.

Optionally, the substantially homogeneous magnetic field can have a magnetic field strength which is less than 100 mT, in particular less than 50 mT, more particularly less than 25 mT.

Elegantly, the picking surface can comprise a transport surface which during picking travels in a transport direction along the at least one picker.

Advantageously, the static magnet may be arranged under the picking surface, such that the substantially homogeneous magnetic field extends parallel along the picking surface. In particular in combination with the above-described transport surface, while the substantially homogeneous magnetic field extends in the transport direction.

Advantageously, the sensor device may be arranged on the static magnet.

Elegantly, the sensor device can comprise a plurality of magnetic field sensors, each with a known relative position with respect to each other, and in particular with the plurality of magnetic field sensors forming an array.

Advantageously, the at least one picker may be controlled by a control to pick free objects off the picking surface and to leave objects with mutual overlap lying on the picking surface.

It is noted that the technical features described in the above paragraphs of the methods and picking apparatuses described can also be seen independently or in combination with one or more technical features from the (main) claim, the subclaims or the description, as inventions. That is to say, the individual technical features can, if desired, be isolated from their context and be applied alone, and, if desired, be combined with one or more of the above-mentioned features.

The invention will be further elucidated on the basis of an exemplary embodiment of a picking apparatus which is shown in drawings. In the drawings:

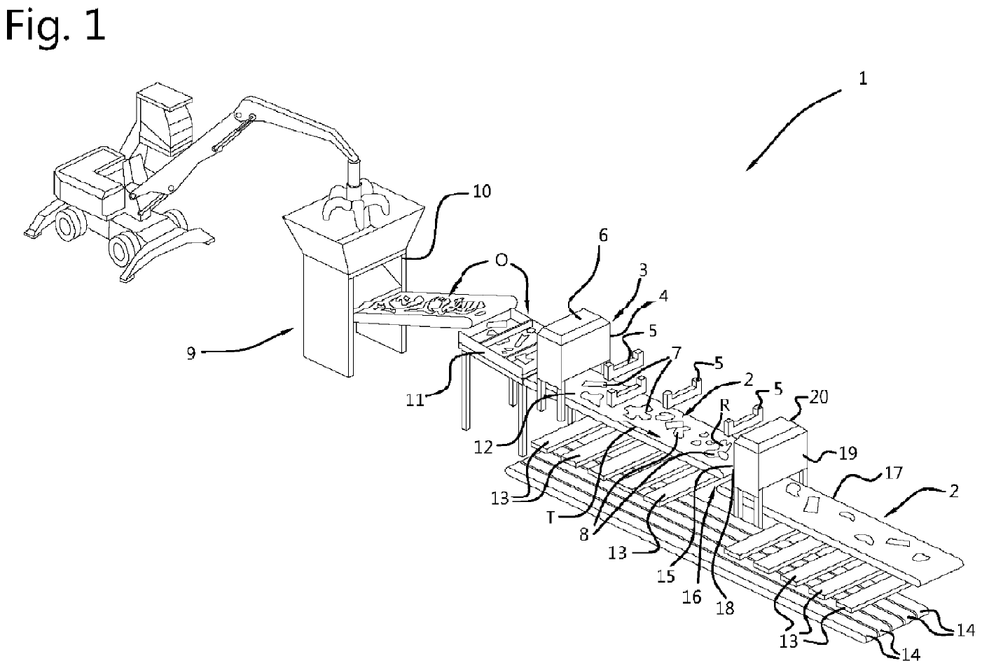

FIG. 1 is a schematic perspective view of a picking apparatus according to the invention;

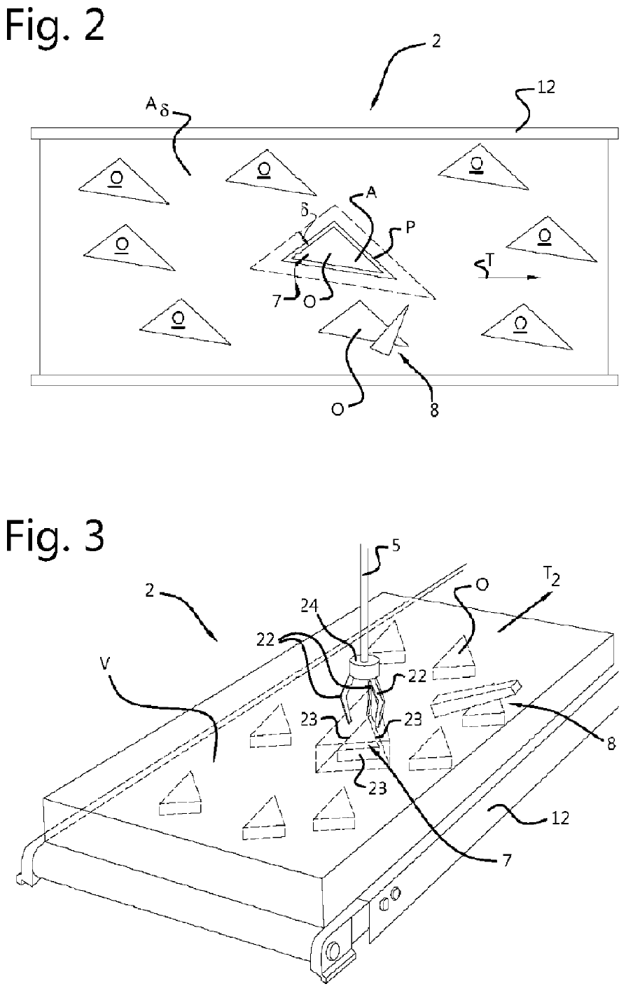

FIG. 2 is a schematic top plan view of a surface on which are objects with a spread remaining equal, according to an aspect of the invention;

FIG. 3 is a schematic perspective view of the surface of FIG. 2;

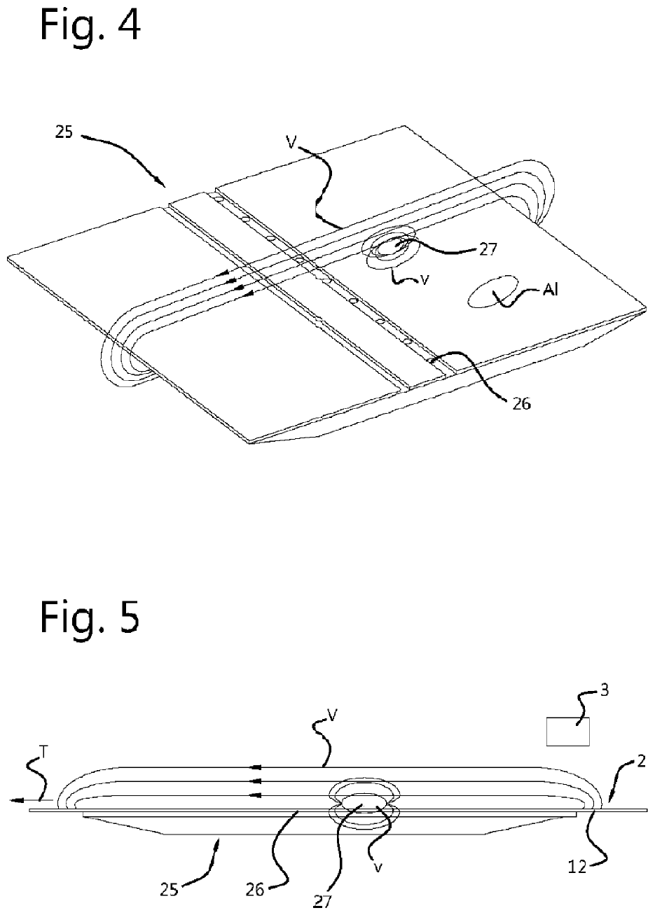

FIG. 4 is a schematic perspective view of a static magnet according to a further aspect of the invention; and

FIG. 5 is a schematic side view of the static magnet of FIG. 4 under a picking surface according to a third embodiment of the invention.

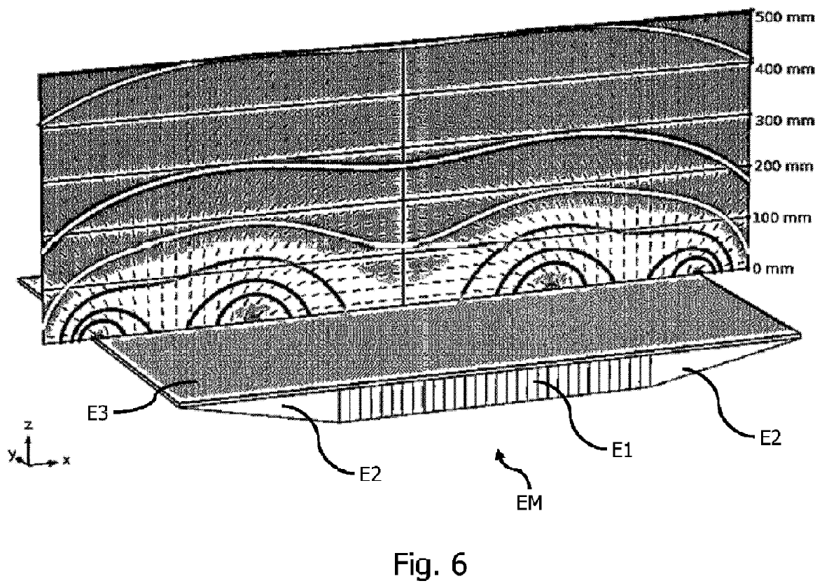

FIGS. 6-10 concern in addition aspects of tests that are described in Example 1 and Example 2 of the current disclosure.

It is noted that the figures are only schematic representations and are shown by way of exemplary embodiment and should not be considered to be limiting in any way. In the implementation examples, with the different embodiments like or corresponding parts are represented with the same reference numerals.

FIG. 1 shows a picking apparatus 1. The picking apparatus 1 comprises a picking surface 2 for spreading objects O thereon. The picking surface 2 shown comprises multiple objects O, which originate from scrap, in particular Zorba and aluminium scrap. The picking apparatus 1 is in particular suitable for processing metal scrap, such as bronze scrap, brass scrap, zinc scrap, refined scrap and iron scrap. The picking apparatus is provided with a scanner 3 for establishing a position (understood to include orientation) of the objects O on the picking surface 2. In this case, the scanner 3 comprises at least one optical sensor 4. The scanner 3 is furthermore configured for determining a 3D height map and material type of the objects on the surface. For this, the represented scanner 3 with optical sensor(s) 4 comprises infrared capability for the 3D height map and colors and reflection detectors for determination of the material types.

The picking apparatus 1 comprises a plurality of pickers 5, in particular relatively inexpensive ‘dumb’ pickers 5 which are unaware of their absolute spatial position. In the exemplary embodiment shown, four pickers 5 are arranged along the picking surface 2. The plurality of pickers 5 are centrally controlled by a control 6 in a master/slave configuration whereby the slave configuration of the ‘dumb’ pickers 5 is limited to passive feedback. The control 6 is configured to control the plurality of pickers 5 to pick free objects 7 off the picking surface 2 and to leave objects 8 with a mutual overlap lying there. In particular, the control 6 is configured so as, with a greedy algorithm, on the basis of a covering capacity, to preferentially select objects being relatively large with respect to others. The picking apparatus 1 comprises a feeding device 9 which is configured to spread objects O randomly on the picking surface 2. To this end, the feeding device 9 comprises a cutting provision 10 for cutting objects O into pieces having a largest dimension D in the range of 30 mm to 500 mm, preferably between 50 mm and 300 mm. The feeding device 9 comprises furthermore a screening provision 11 for sieving objects O of a screen size D′ which is less than 20 mm. In the exemplary embodiment shown, a conveyor is arranged between the cutting provision 10 and the screening provision 11 of the feeding device 9. From the screening provision 11, the objects O are randomly spread on a picking surface 2 which comprises a transport surface 12. The transport surface 12 travels during picking in a transport direction T along the plurality of pickers 5.

The picking apparatus 1 comprises five discharges 13 for sorting and discharging picked objects O on the basis of the determined material type. Advantageously, each discharge 13 can correspond to a particular material type and/or alloy class. To this end, the discharge 13 comprises a separate discharge channel 14 for each material type.

Furthermore, the picking apparatus 1 comprises a respreader 15 for respreading objects R remaining on the picking surface 2. In the exemplary embodiment shown, the respreader 15 comprises a transition 16 from the transport surface 12 to a further transport surface 17, with the transition 16 forming a cascade 18. Additionally or alternatively, the respreader 15 can comprise a shaking device for shaking up the remaining objects R so that that these are respread.

Furthermore, the picking apparatus 1 comprises for the further transport surface 17 a second scanner 19 and a second plurality of pickers (not shown). Alternatively or additionally, the scanner 3 may be so arranged as to survey both transport surfaces 12, 17, e.g. by having the scanner 3 switch physically between the transport surfaces 12, 17, or scan both transport surfaces 12, 17 simultaneously or alternately via reflectors and/or mirrors. The second plurality of pickers are centrally controlled by a second control 20. Alternatively, the second plurality of pickers may be centrally controlled by the control 6 and in that case a second control is not necessary. In addition, more than two respreads may take place, for instance by arranging a plurality of transport surfaces, each with a respreader, one after the other.

FIG. 2 and FIG. 3 show a picking surface 2 on which are objects O with a spread remaining equal. The picking surface comprises a transport surface 12 which travels in a transport direction T. A minimum free circumferential zone 21 of 25 mm is shown around the free object 7. Furthermore, on the surface 2 are objects with mutual overlap 8. Also represented are parameters for the greedy algorithm, where A is the projection area of an object on the surface 2 and P is the convex circumference (perimeter) of the object. The greedy algorithm works according to a covering capacity principle, taking into account both the projection area A of objects on the surface 2 and a convex circumference P of objects lying on the surface, according to the function

$$A + \frac{{P}^{2}}{2 π}$$

In FIG. 3 a ‘dumb’ picker 5 is shown with three fingers 22 movable independently of each other. The fingers 22 are configured to each engage a free object 7 at different points 23. The points of engagement 23 are predetermined by the control 6, 20, as, for instance, on the basis of the 3D scan of the object with an assessment of its center of gravity. The picker 5 is provided with a strain gauge 24. The control 6, 20 can, with the aid of the passive feedback of the picker 5, compare data of the strain gauge 24 on a real mass of the object with a mass predetermined by the control 6, 20. When the ratio between the real mass and the predetermined mass exceeds a particular threshold value, as, for example, less than 0.7 or more than 1.3, less than 0.8 or more than 1.2, or otherwise, the control 6, 20 controls the relevant picker 5 to put the object O aside. This may be, for example, in a discharge 13 suitable therefor.

FIG. 4 represents a static magnet 25. The static magnet 25 is provided with a plurality of magnetic field sensors 26, in particular Hall sensors and/or inductive sensors such as pickup coils. The static magnet 25 generates a substantially homogeneous magnetic field V. The magnetic field sensors 26 are arranged transversely to the substantially homogeneous magnetic field V of the static magnet 25 with an equal spacing. The substantially homogeneous magnetic field V induces a magnetic moment v in ferromagnetic objects 27, which is observed by the magnetic field sensors 26. In FIG. 5 the static magnet 25 is arranged under the picking surface 2, in particular the picking surface 2 of the picking apparatus 1 of FIGS. 1-3. The scanner 3 is above the picking surface 2. The picking surface 2 is a transport surface 12 which travels in the transport direction T over the static magnet 25. The uniformly distributed magnetic field V magnetizes a ferromagnetic object 27. As a result, ferromagnetic objects 27 can be relatively simply separated from other objects O.

The transport surface 12 travels in the transport direction T along at least one picker (not shown). The substantially homogeneous magnetic field V extends parallel along the transport surface 12 in the transport direction T. The static magnet 25 magnetizes with the aid of its substantially homogeneous magnetic field V the ferromagnetic object 27 which moves on the transport surface 12 in the transport direction T over the static magnet 25. The substantially homogeneous magnetic field V of the static magnet 25 has a strength of 25 mT and has a magnetic field strength gradient of 50 mT/m. By implementing the static magnet 25 with a relatively weak magnetic field, movement of the ferromagnetic object 27 by magnetic attraction is counteracted. Further, due to the relatively low gradient, movement of the ferromagnetic object 27 along it (i.e., along the gradient) is counteracted. This can further promote the spread of objects on the surface remaining equal, while ferromagnetic objects 27 can be relatively simply observed. The plurality of magnetic field sensors 26, each with a known relative position with respect to each other, constitute the sensor device. The plurality of magnetic field sensors 26 are thus arranged in a series or array transversely to the substantially homogeneous magnetic field V, in particular the plurality of magnetic field sensors 26 are arranged on a side of the static magnet 25 proximal to the transport surface 12. In this way, the size of the ferromagnetic object 27 can be estimated in conjunction with the distance to the sensor device, for instance when the ferromagnetic object 27 travels on the transport surface 12 over the static magnet 25, in particular the magnetic field sensors 26 arranged on the static magnet 25.

It is noted that the invention is not limited to the exemplary embodiment described here. The picking apparatus may for instance comprise a picking surface with integrated respreader, which itself shakes up objects for respreading objects remaining on the picking surface. In addition, the pickers may be implemented as wipers which are configured to wipe free objects at a periphery of the established position of the objects on the picking surface and to leave objects with mutual overlap lying on the picking surface.

Such variants will be clear to one skilled in the art and are understood to be within the scope of the invention, as set forth in the appended claims.

The current disclosure comprises the following numbered exemplary embodiments.

### Exemplary Embodiment 1

Method for picking up off a surface objects which are on the surface with a spread remaining equal, wherein of the objects a position on the surface is established, and wherein on the basis of the established position a plurality of pickers are centrally controlled to pick free objects off the surface and to leave objects with mutual overlap lying on the surface.

### Exemplary Embodiment 2

Method according to exemplary embodiment 1, wherein the plurality of pickers are controlled to leave objects abutting each other lying on the surface.

### Exemplary Embodiment 3

Method according to exemplary embodiment 1 or 2, wherein the plurality of pickers are controlled to pick up only free objects with a minimum free circumferential zone around the object, in particular a minimum free circumferential zone from the circumference of the free object projected on the surface, of between 5-50 mm, preferably between 10-40 mm and more preferably between 20-30 mm.

### Exemplary Embodiment 4

Method according to any one of the preceding numbered exemplary embodiments, wherein the plurality of pickers are centrally controlled to execute commands blindly, in particular wherein each picker of the plurality of pickers is unaware of its absolute spatial position.

### Exemplary Embodiment 5

Method according to any one of the preceding numbered exemplary embodiments, wherein of the objects a 3D scan, in particular an infrared 3D scan, is taken, wherein on the basis of the 3D scan a height map of the objects on the surface is determined.

### Exemplary Embodiment 6

Method according to any one of the preceding numbered exemplary embodiments, wherein the objects spread on the surface give the surface a degree of coverage which is in the range of 10-40% of the area of the surface, and in particular is at least 15% of the area of the surface, and in particular is not more than 30% of the area of the surface.

### Exemplary Embodiment 7

Method according to any one of the preceding numbered exemplary embodiments, wherein at least 40% of the objects on the surface have an overlapping position, preferably at least 60%, and in particular less than 90% of the objects on the surface have an overlapping position.

### Exemplary Embodiment 8

Method according to any one of the preceding numbered exemplary embodiments, wherein the pickers are controlled to preferentially pick free objects off the surface that are relatively large with respect to others, in particular free objects with a relatively large covering capacity with respect to others, more particularly with the aid of a greedy algorithm.

### Exemplary Embodiment 9

Method according to any one of the preceding numbered exemplary embodiments, wherein a substantially homogeneous magnetic field and the surface with objects are moved relative to, along each other, such that the substantially homogeneous magnetic field excites a magnetic moment in ferromagnetic objects being on the surface, while the spread of the objects on the surface remains equal, wherein the excited magnetic moment, at least a component thereof, is observed.

### Exemplary Embodiment 10

Method according to any one of the preceding numbered exemplary embodiments, wherein the pickers are controlled, at picking, to leave objects bounding the free circumferential zone untouched.

### Exemplary Embodiment 11

Method according to any one of the preceding numbered exemplary embodiments, wherein the pickers are controlled, at picking, to counteract both rotation of the object relative to the surface and translation of the object along the surface, in particular by engaging the objects to be picked up at three predetermined points.

### Exemplary Embodiment 12

Method according to any one of the preceding numbered exemplary embodiments, wherein the pickers are controlled, upon picking up of the objects, to move substantially transversely to the surface.

### Exemplary Embodiment 13

Method according to any one of the preceding numbered exemplary embodiments, wherein the surface during picking travels, preferably in a transport direction along the pickers.

### Exemplary Embodiment 14

Method according to any one of the preceding numbered exemplary embodiments, wherein on the surface remaining objects are respread, wherein, of the respread objects, a next position on the surface is established, and wherein on the basis of the established next positions, again a plurality of pickers are controlled to pick up free objects off the surface and to leave objects with mutual overlap lying on the surface.

### Exemplary Embodiment 15

Method according to any one of the preceding numbered exemplary embodiments, wherein objects which are on the transport surface with a mutual spread remaining equal are part of a waste flow, in particular metal scrap, more particularly a flow of Zorba and/or aluminium scrap.

### Exemplary Embodiment 16

Method according to exemplary embodiment 15, wherein of the objects, a material type, in particular a type of metal or class of alloy, is determined, and wherein the picked-up objects are sorted according to material type.

### Exemplary Embodiment 17

Method according to exemplary embodiments 14, 15 and 16, wherein of the remaining objects, again a material type is determined, wherein with a feedforward, data on the previously determined types of material of objects are put through.

### Exemplary Embodiment 18

Picking apparatus comprising a picking surface for spreading objects thereon, wherein the picking apparatus is provided with a scanner for establishing a position of the objects on the picking surface, wherein the picking apparatus furthermore comprises a plurality of pickers, which are arranged along the picking surface and are centrally controlled by a control to pick up free objects off the picking surface and to leave objects with mutual overlap lying on the picking surface.

### Exemplary Embodiment 19

Picking apparatus according to exemplary embodiment 18, wherein the picking apparatus comprises a feeding device which is configured to spread objects randomly on the picking surface, wherein the feeding device is configured to bring about with the spread objects a degree of coverage of the picking surface in the range of 10-40% of the area of the picking surface, and in particular is at least 15% of the area of the picking surface, and in particular is not more than 30% of the area of the picking surface, such that due to the random spread and the degree of coverage at least a part of the objects are on the picking surface with mutual overlap.

### Exemplary Embodiment 20

Picking apparatus according to exemplary embodiment 18 or 19, wherein the picking apparatus comprises at least one discharge for discharging picked-up objects.

### Exemplary Embodiment 21

Picking apparatus according to any one of the exemplary embodiments 18-20, wherein the scanner comprises at least one optical sensor which is configured for taking a 3D scan.

### Exemplary Embodiment 22

Picking apparatus according to any one of the exemplary embodiments 18-21, wherein the control and the plurality of pickers are arranged respectively in a master/slave configuration, wherein the pickers blindly execute commands from the control, wherein each of the pickers is unaware of its absolute spatial position, and wherein the slave configuration of the pickers is limited to passive feedback.

### Exemplary Embodiment 23

Picking apparatus according to any one of the exemplary embodiments 18-22, comprising a static magnet with a substantially homogeneous magnetic field, wherein the static magnet and the picking surface are arranged in a manner movable relative to, along each other, wherein the picking apparatus is furthermore provided with a sensor device which is configured for observing a magnetic moment, excited by the substantially homogeneous magnetic field, in ferromagnetic objects being on the picking surface.

### Exemplary Embodiment 24

Picking apparatus according to any one of the exemplary embodiments 18-23, wherein each of the plurality of pickers comprises three fingers movable independently of each other, wherein the fingers are configured to each engage an object at different points, wherein points of engagement are predetermined by the control.

### Exemplary Embodiment 25

Picking apparatus according to any one of the exemplary embodiments 18-24, wherein the picking surface comprises a transport surface which during picking travels in a transport direction along the plurality of pickers.

### Exemplary Embodiment 26

Picking apparatus according to any one of the exemplary embodiments 18-25, wherein the picking apparatus comprises a respreader for respreading objects remaining on the picking surface, in particular according to exemplary embodiment 19, wherein the respreader comprises a transition from the transport surface to a further transport surface, wherein the transition is or forms a cascade.

### Exemplary Embodiment 27

Picking apparatus according to exemplary embodiment 25 or 26, wherein the picking apparatus for the further transport surface comprises a second scanner and a second plurality of pickers, wherein the second plurality of pickers are centrally controlled by the control and/or a second control to pick up free objects off the further transport surface and to leave objects with mutual overlap lying on the further transport surface.

### Exemplary Embodiment 28

Picking apparatus according to any one of the exemplary embodiments 18-27, wherein the plurality of pickers are or comprise at least five pickers.

### Exemplary Embodiment 29

Picking apparatus according to any one of the exemplary embodiments 18-28, wherein each of the pickers comprises a mass determination provision.

### Exemplary Embodiment 30

Picking apparatus according to any one of the exemplary embodiments 18-29, wherein the picking apparatus is configured to process Zorba, aluminium scrap, iron scrap and/or like scrap, wherein the objects to be spread have substantially a mass in the range of 0.01 kg to 0.5 kg, preferably between 0.03 kg and 0.3 kg, and a largest dimension in the range of 30 mm to 500 mm, preferably between 50 mm and 300 mm.

### Exemplary Embodiment 31

Picking apparatus according to exemplary embodiment 30, wherein the feeding device comprises a cutting provision for cutting objects into pieces having a largest dimension in the range of 30 mm to 500 mm, preferably between 50 mm and 300 mm.

### Exemplary Embodiment 32

Picking apparatus according to exemplary embodiment 30 or 31, wherein the feeding device comprises a screening provision for sieving objects with a screen size which is less than 20 mm.

### Exemplary Embodiment 33

Picking apparatus according to any one of the exemplary embodiments 18-32, wherein the control on the basis of data from the scanner controls the pickers to sort objects of a particular material type, in particular a type of metal or class of alloy, into the corresponding discharge, wherein the discharge comprises a separate discharge channel for each material type.

### Exemplary Embodiment 34

Picking apparatus according to any one of the exemplary embodiments 18-33, wherein the control comprises a greedy algorithm which is configured to preferentially pick off the picking surface free objects being relatively large with respect to others, in particular free objects having a covering capacity being relatively large with respect to others.

### EXAMPLES

### Example 1

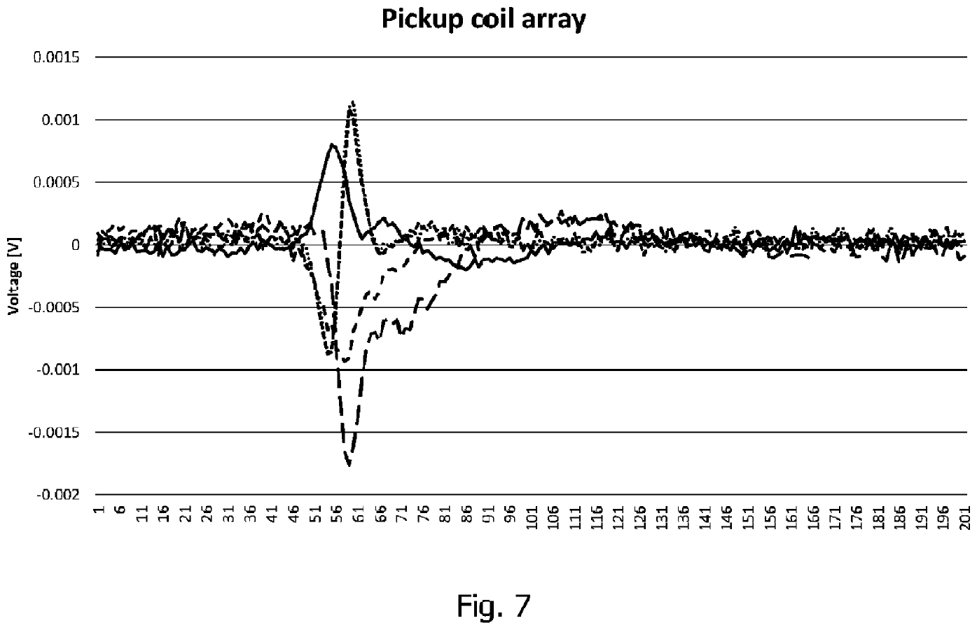

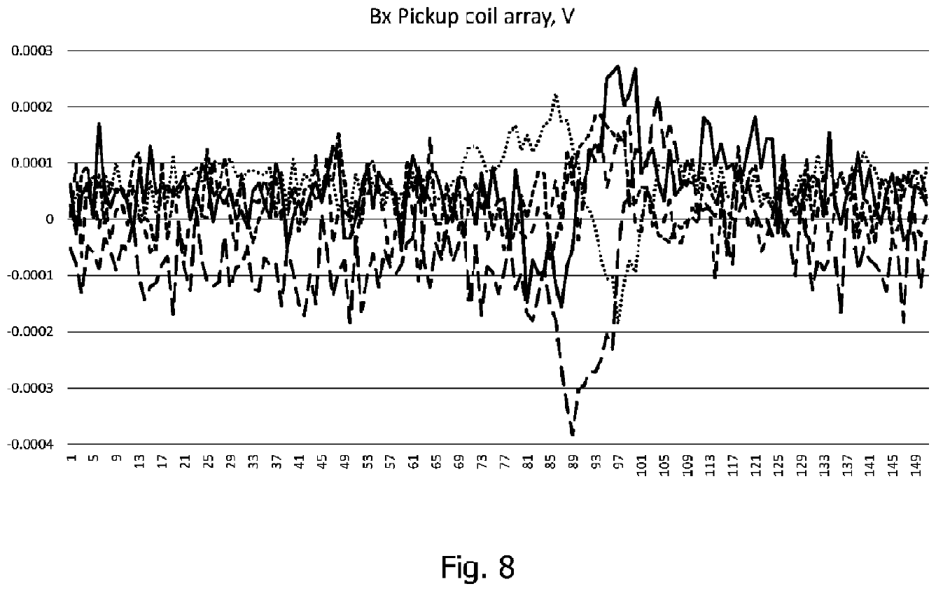

A test was carried out on scrap particles and steel contaminants of an industrial flow of aluminium scrap with a size range of 100-180 mm. The magnet used (see FIG. 6) comprised a middle section of permanent iron-neodymium-boron of 0.6 m length and 0.9 m width, magnetized in the direction of transport of the scrap (x-direction), fitted with two end sections of steel to reduce concentrations of the field near the edges of the permanent section. The magnet was placed 10 mm below the conveyor belt, and produced a substantially homogeneous field of ca 40 mTesla in a volume of 0.3 m length (x), 0.8 m width (y) and 0.1 m height (z) above the belt. A pickup coil array (each element 6 mm diameter, 68 mH sensitivity, measuring fluctuations of B_x only, noise level ca 2 mTesla/s) was positioned at x=0 (at the centre of the length of the magnet) in the 10 mm space just below the belt and above the magnet. The signal from the elements of the array was sampled at 400 Hz and filtered digitally with a fifth-order low pass filter (cut frequency 181 Hz). Additionally, the coils also had an electronic first-order low pass filter with a cut frequency at 338 Hz. As a representative of the smallest steel contaminant, a steel nut of 2.2 grams was passed over the magnet and sensor array with a speed of 2.5 m/s at a height of 22 mm above the conveyor belt, whereby a clear signal with a peak of 1-2 mVolt was produced from the elements of the array closest to the path of the nut, as shown in FIG. 7. As a representative of the largest aluminium scrap particles in the flow, a scrap particle with a wall thickness of 2 mm and a mass of 423 g was passed over the system, whereby a maximum signal of only 0.2-0.4 mVolt was produced, as shown in FIG. 8.

FIG. 6 shows the magnet EM with the permanent magnet section E1 in the middle and triangular steel end sections E2, fitted with a stainless steel plate E3 on top. Above the middle section a volume of ca 100 mm height shows a substantially homogeneous field of ca 40 mTesla parallel to the direction of motion (x-direction).

FIG. 7 shows signals produced from several respective elements of the pickup coil array, on passing a steel nut of 2.2 grams over the array at a speed of 2.5 m/s, at a height of 22 mm above the belt.

FIG. 8 shows signals produced from several respective elements of the pickup coil array, on passing an aluminium scrap particle of 423 grams over the array at a speed of 2.5 m/s, the particle resting directly on the belt.

### Example 2

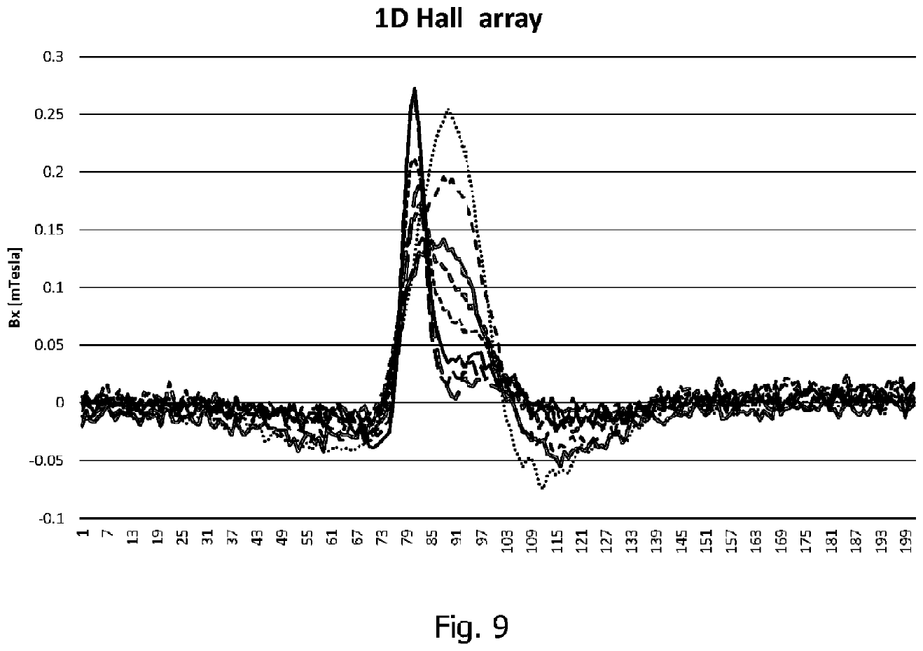

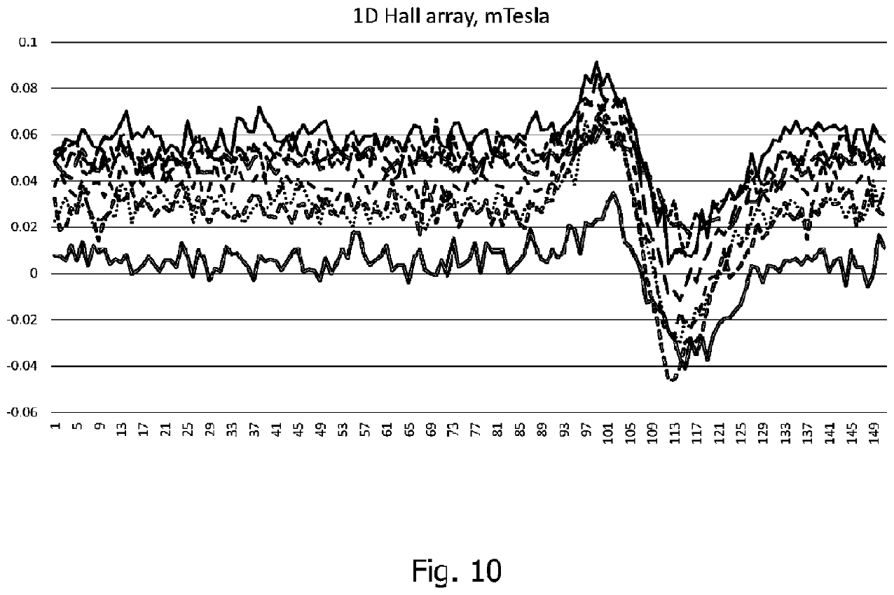

The same magnet and the same scrap particle and the same steel contaminant as in Example 1 were tested, but now with a one-dimensional Hall sensor array which measured B_x only (each element with a range of 300 mTesla, noise level ca 10 microTesla) at x=0.1 m. All signals were filtered digitally with a fifth-order low pass filter (cut frequency 181 Hz). The resulting signals from the steel contaminant and the aluminium scrap particle are shown in FIG. 9 and FIG. 10, respectively.

FIG. 9 shows signals produced from several respective elements of the one-dimensional Hall array, on passing a steel nut of 2.2 grams over the array at a speed of 2.5 m/s, at a height of 22 mm above the belt.

FIG. 10 shows signals produced from several respective elements of the one-dimensional Hall array, on passing an aluminium scrap particle of 423 grams over the array at a speed of 2.5 m/s, the particle resting directly on the belt.

### LIST OF REFERENCE NUMERALS

1. Picking apparatus
2. Picking surface
3. Scanner
4. Optical sensor
5. Plurality of pickers
6. Control
7. Free objects
8. Objects with mutual overlap
9. Feeding device
10. Cutting provision
11. Screening provision
12. Transport surface
13. Discharge
14. Discharge channel
15. Respreader
16. Transition
17. Further transport surface
18. Cascade
19. Second scanner
20. Second control
21. Minimum free circumferential zone
22. Three fingers movable independently of each other
23. Points of engagement
24. Strain gauge
25. Static magnet
26. Magnetic field sensors
27. Ferromagnetic object
A. Projection area of an object on the (picking) surface
O. Object
P. Convex circumference of object
R. Remaining objects
T. Transport direction
D. Largest dimension object
D′. Screen size
V. Substantially homogeneous magnetic field
v. magnetic moment
EM. Magnet used in Example 1 and Example 2
E1. Permanent magnet section of magnet EM
E2. Triangular steel end section of magnet EM
E3. Stainless steel plate of magnet EM

1.-15. (canceled)

16. A method for picking up off a surface objects which are on the surface with a spread remaining equal, wherein of the objects a position on the surface is established, wherein on the basis of the established position at least one picker is controlled to pick up objects off the surface, wherein a substantially homogeneous magnetic field and the surface with objects are moved relative to each other, such that the substantially homogeneous magnetic field excites a magnetic moment in ferromagnetic objects being on the surface while the spread of the objects on the surface remains equal, wherein the excited magnetic moment, at least a component thereof, is observed.

17. The method according to claim 16, wherein the substantially homogeneous magnetic field comprises a magnetic field strength gradient which is less than 200 mT/m.

18. The method according to claim 17, wherein the substantially homogeneous magnetic field comprises a magnetic field strength gradient which is less than 100 mT/m.

19. The method according to claim 18, wherein the substantially homogeneous magnetic field comprises a magnetic field strength gradient which is less than 50 mT/m.

20. The method according to claim 16, wherein the substantially homogeneous magnetic field has a magnetic field strength which is less than 100 mT.

21. The method according to claim 16, wherein the magnetic moment, at least a component thereof, is observed with the aid of a sensor device.

22. The method according to claim 16, wherein on the basis of the observed magnetic moment a position of the ferromagnetic object is established.

23. The method according to claim 16, wherein on the basis of the observed magnetic moment a dimension of the ferromagnetic object is established.

24. The method according to claim 16, wherein on the basis of the established position the at least one picker is controlled to pick up free objects off the surface and to leave objects with mutual overlap lying on the surface.

25. A picking apparatus comprising a picking surface for spreading objects thereon, a scanner for establishing a position of the objects on the picking surface, at least one picker which is arranged along the picking surface to pick objects off the picking surface, a static magnet with a substantially homogeneous magnetic field, wherein at least one of the static magnet and the picking surface is arranged movably relative to the other, wherein the picking apparatus is furthermore provided with a sensor device which is configured for observing a magnetic moment, excited by the substantially homogeneous magnetic field, in ferromagnetic objects being on the picking surface.

26. The picking apparatus according to claim 25, wherein the substantially homogeneous magnetic field comprises a magnetic field strength gradient which is less than 200 mT/m.

27. The picking apparatus according to claim 25, wherein the substantially homogeneous magnetic field has a magnetic field strength which is less than 100 mT.

28. The picking apparatus according to claim 25, wherein the picking surface comprises a transport surface which during picking travels in a transport direction along the at least one picker.

29. The picking apparatus according to claim 28, wherein the static magnet is arranged under the picking surface, such that the substantially homogeneous magnetic field extends in the transport direction and parallel along the picking surface.

30. The picking apparatus according to claim 25, wherein the sensor device is arranged on the static magnet.

31. The picking apparatus according to claim 30, wherein the sensor device comprises a plurality of magnetic field sensors, each with a known relative position with respect to each other.

32. The picking apparatus according to claim 31, wherein the plurality of magnetic field sensors form an array.

33. The picking apparatus according to claim 25, wherein the sensor device comprises one or more Hall sensors.

34. The picking apparatus according to claim 25, wherein the sensor device comprises one or more pickup coils.

35. The picking apparatus according to claim 25, wherein the at least one picker is controlled by a control to pick free objects off the picking surface and to leave objects with mutual overlap lying on the picking surface.
